(19) United States
(12) Patent Application Publication
(10) Pub. No.: US 2009/0199112 A1
(43) Pub. Date: Aug. 6, 2009

(54) SIMPLIFIED OPC TO WPF XAML BINDING METHOD

(76) Inventor: Allen DeSerranno, Beverly Hills, FL (US)

Correspondence Address: Lauson & Tarver LLP, 880 Apollo Street, SUITE 301, El Segundo, CA, 90245, US

(21) Appl. No.: 12/341,915

(22) Filed: Dec. 22, 2008

Related U.S. Application Data
(60) Provisional application No. 61/026,042, filed on Feb. 4, 2008.

(51) Int. Cl. G06F 3/00

(52) U.S. Cl. 715/760

(57) ABSTRACT

A method of obtaining real-time OPC (OLE for Process Control) data from industrial control systems, financial data and other sources in a uniform and generic manner without extensive programming binds the data to properties on user interface components in Microsoft .NET Windows and Silverlight applications. This is accomplished using a custom .NET Binding class (Generic Binding) with additional properties and a set of predefined interfaces that abstract the source of the data, and the data items being bound to allowing a software application to connect to a variety of real time data sources, query available items for binding, and connect to those items regardless of the source of the underlying data and the communication protocol used to provide the data. In addition, the binding mechanism uses ‘aliases’ in the descriptions of the data items being bound to, allowing a binding to seemly change the underlying object changing the data without having to modify, change or recreate the binding to the data.

### CROSS-REFERENCE TO RELATED APPLICATION

This application claims the benefit of the priority filing date of provisional application No. 61/026,042, filed on Feb. 4, 2008.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Access to real-time data is essential to computer applications, financial data and industrial control systems. The ability to continuously update information from a data source and respond to the data is well developed in the software arts.

However, in the current art, transmitting data and displaying the information in a user interface typically requires months of programming and thousands of lines of computer code; particularly when continuously updated data is required. This is because connectivity requires substantial coding and a detailed understanding of underlying individual specifications. Even within individual specifications, the syntax and communication protocols can vary significantly. In the case of industrial control system data, data is transmitted using the OPC (Object Linking and Embedding for Process Control) specification. This data is made available as OPC-Data Access which uses Distributed Component Object Model (DCOM) for communications; alternatively, Extensible Markup Language Data Access (XML-DA) or OPC Unified Architecture (OPC-UA) could be used.

Because of the importance of obtaining real time data from OPC and other disparate data sources, there is a need for a process by which different kinds of data can be quickly and easily delivered to a user interface in real time using a single mechanism.

Extensible Application Markup Language (XAML) is an Extensible Markup Language (XML) markup language used to define user interfaces and bind data to user interface controls in Microsoft .NET Windows and Silverlight applications. While the binding mechanism is very comprehensive, it is quite static where the item bound-to and the data item bound-to is fixed and permanent unless destroyed and replaced with a different binding.

Within industrial control systems, there is often duplication where a motor or a tank, possibly an entire production line is an exact duplicate of another on the plant floor. When creating visualization screens for monitoring equipment, it is desirable to allow a graphic to bind to one piece of data at one point in time and switch to allow it to bind to another piece of equipment at a different point in time. In allowing this, there is no need to create duplicate visualization screens of the same equipment with bindings to different data. This presents a challenge in that the data item being bound to in XAML markup is hard wired to a property on a graphic in the display. A mechanism is needed that allows the changing of the underlying data such that the graphic can be reused in the same display and be bound to different sources of data at different points in time.

It is therefore an object of the present invention to bind disparate types of real time data using different communication protocols to a user interface defined by the Extensible Application Markup Language (XAML) language using a single uniform mechanism. A further object of the invention is to provide a mechanism where the underlying data used for a binding in XAML can change to provide data from a different source without the need for destroying and recreating the binding. A further object of the invention is to provide a uniform and consistent method of binding data from various kinds of OPC data (OPC-DA, OPC-XMLDA, and OPC-UA) to graphics in real time Microsoft .NET Windows and Silverlight applications.

### SUMMARY

The present invention comprises a method of binding disparate data from different sources using different communication protocols to an Extensible Application Markup Language (XAML) document, thereby marrying the data in real-time to any user interface defined in XAML markup. This mechanism is coined ‘Generic Binding’.

The present invention comprises a method where the path used to define an item of data can have a relative component, a ‘Path Alias’. This Path Alias allows the path in a binding to change, resulting in the binding using a different data item as its source while maintaining the binding to the graphic display.

The present invention utilizes Generic Binding and Path Aliases to allow for a single uniform mechanism for configuring and binding OPC-DA, OPC-XMLDA and OPC-UA data to graphic displays in Microsoft .NET Silverlight and Windows Applications. The invention allows the graphics defined in XAML to display data from different sources of data while maintaining a single data binding.

### FIGURES

FIG. 1 is a general diagram of the Generic Binding architecture.

FIG. 2 Diagram of the interfaces used to implement Generic Binding and Path Aliasing

FIG. 3 is a diagram of how various flavors of OPC data can be used in the same manner as a data source using Generic Binding.

FIG. 4 is an example of the XAML binding syntax for the present invention showing the binding to the graphic, Path Alias and Generic Binding.

FIG. 5 is an example of a gauge that has been bound to a data source using Generic Binding and Path Aliasing.

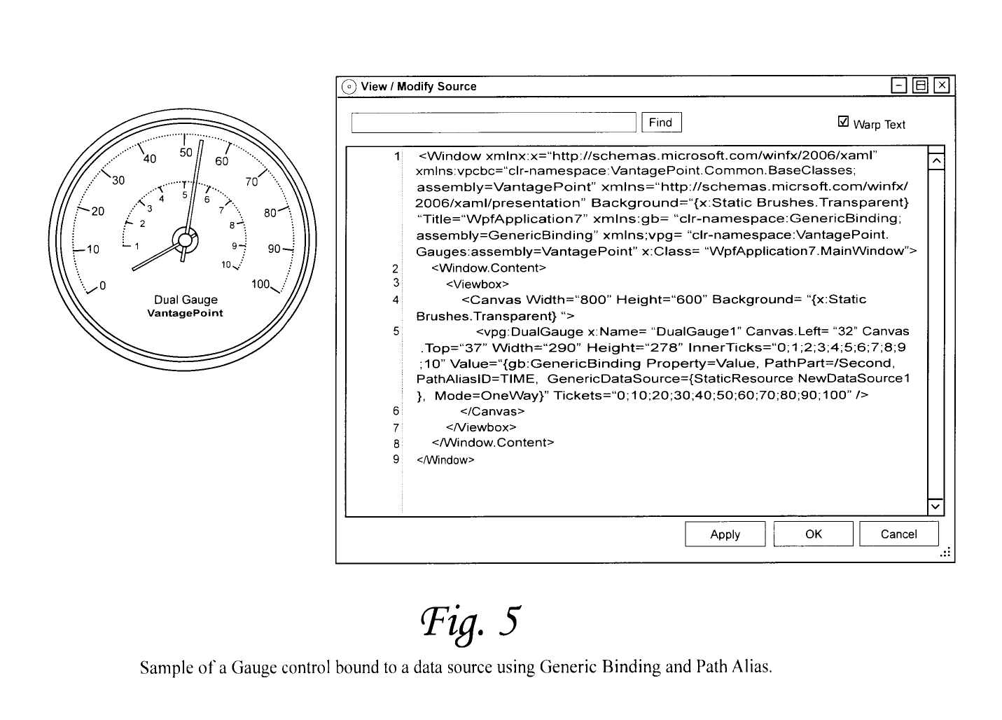

### DESCRIPTION

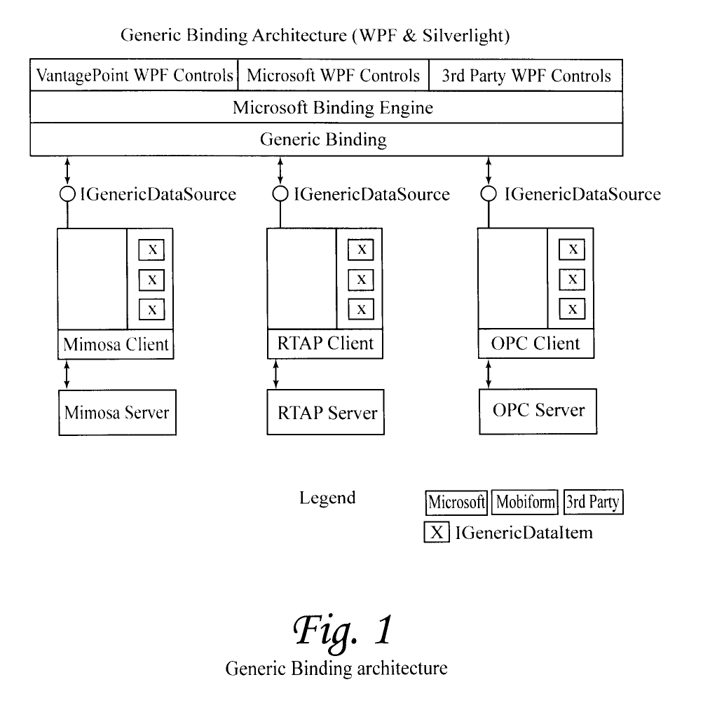

Referring to FIG. 1, the present invention is directed to a computerized method of providing continuously updated information from industrial control systems, financial data, or other real time data sources in a consistent manner regardless of the type of data or the communication protocol used to retrieve the data. A NET class named Generic Binding talks to a predefined interface, IGenericDataSource. By creating a client stub that can communicate with a source of data on one side and can communicate with Generic Binding via the IGenericDataSource interface on the other, a mechanism is realized where any real time data source can provide data into the binding mechanism regardless of what communication exists between the client stub and the data server.

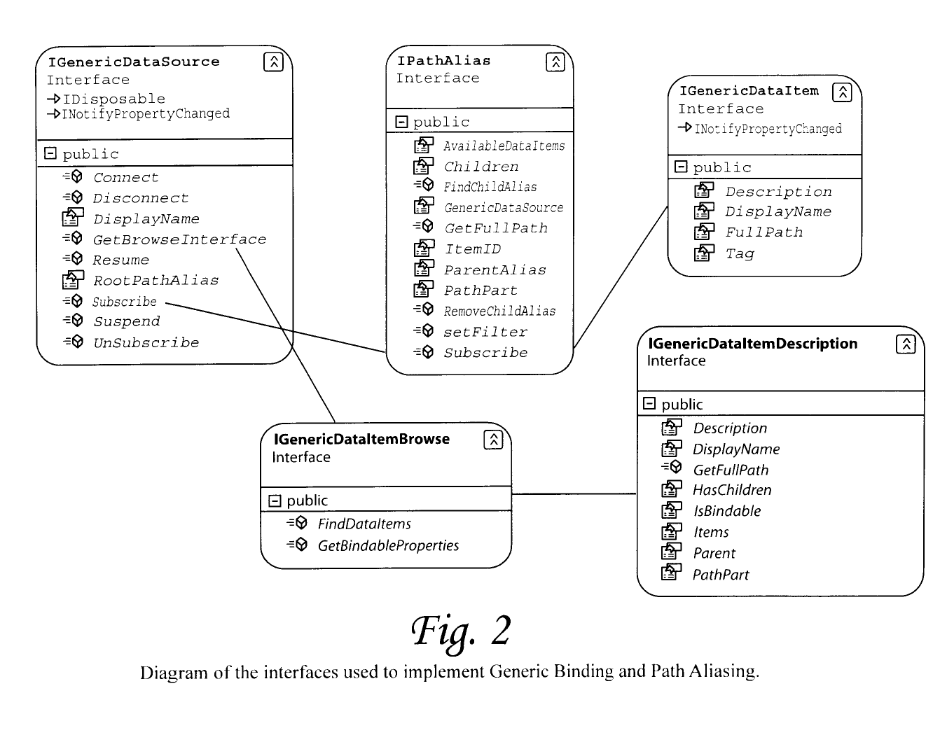

Referring to FIG. 2, data is not only bound using a generic mechanism but configured using a generic mechanism as well. A client application will ask an IGenericDataSource for its IGenericDataItemBrowse interface. The client application can then interrogate the data source and retrieve IGenericDataItemDecriptions of the data items that are available for binding, and the properties on those the items that can be bound to using data binding.

Referring to FIG. 2, once a client has a description of a data item it can ask the IGenericDataSource to provide the item as an lGenericDataItem and an IPathAlias. The IGenericDataSource will pass these back to the caller.

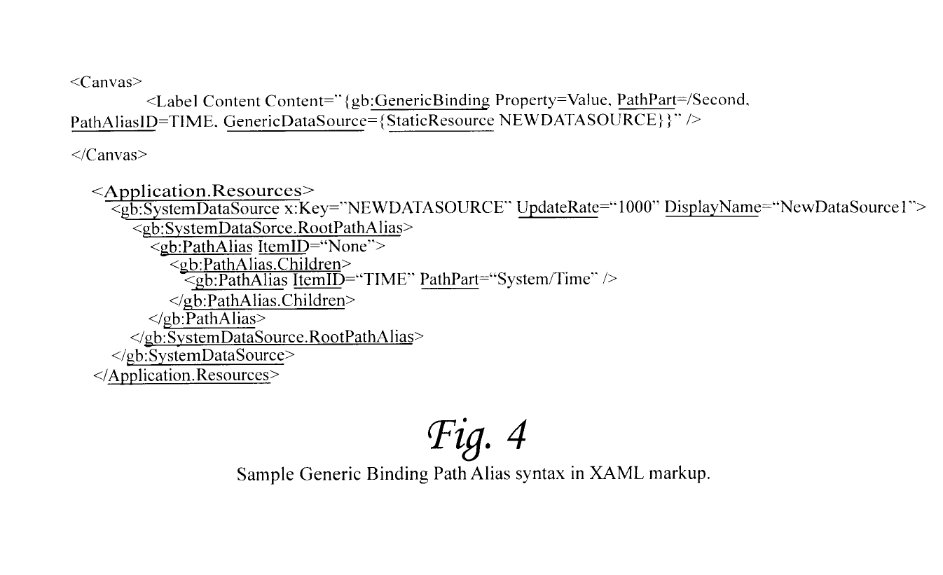

Referring to FIG. 4, Traditional binding in XAML requires a data source, and a property name to bind to. The property normally exists on the data source. In Generic Binding, the data source may contain many thousands of items with the binding occurring on one of those items. When binding occurs in the invention, Generic Binding will ask the IGenericDataSource for the Path Alias by name. This name is located in the binding markup. Generic Binding will ask the Path Alias for an IGenericDataItem to bind to, passing it the Path Part specified in the binding markup. Once the Path Alias passes back the IGenericDataItem Generic Binding will create a traditional NET binding using the IGenericDataItem as the source and using the property specified in the binding markup.

Referring to FIG. 2, IGenericDataItem is a wrapper or a proxy to an underlying piece of data, where the raw data is implemented in a custom format understood only by the IGenericDataSource provider. The IGenericDataItem is identified by the path of the Path Alias and the Path Part concatenated to form the full path describing the item. Path Aliasing, the ability for a data item to change the data it is pointing to, is achieved by changing the path of the Path Alias. As an example, an lGenericDataItem may be described as //Line1/Tank4/Pressure. Where the Path Alias path is //Line1/Tank4 and the Path Part is /Pressure. If the Path Alias is told to change its path to //Line1/Tank5 the Path Alias will notify its child GenericDataItems that the full path describing them has changed. In the case of the IGenericDataItem with a full path description of //Line1/Tank4/Pressure, it will need to change the underlying data it is subscribed to, to correspond to //Line1/Tank5/Pressure. From the Generic Binding perspective, the binding is unchanged with the same IGenericDataItem being bound to, even though the underlying data provided by the IGenericDataItem has changed.

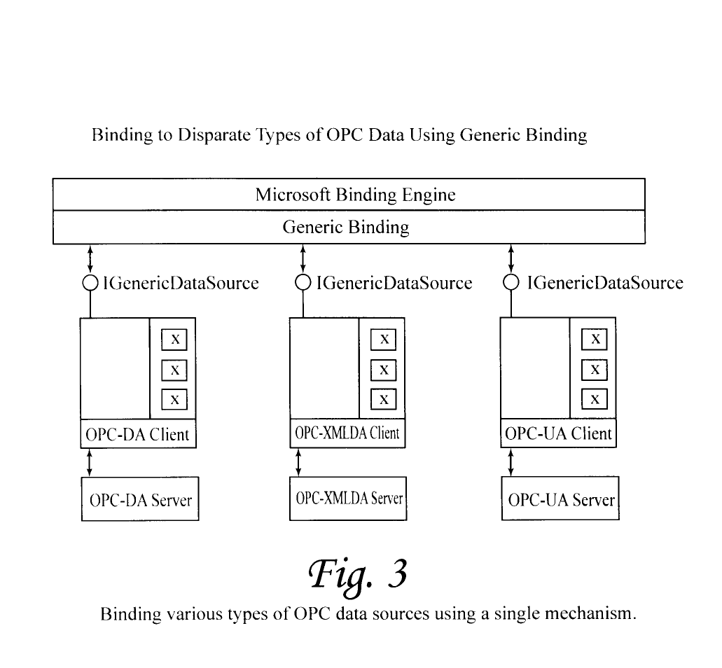

Referring to FIG. 3, using the Generic Binding and Path Aliasing mechanisms, data from different types of OPC servers can be fed into a .NET application in an identical manner. These data sources can coexist in the application, and could even coexist with other types of data not related to process control.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. In a computer processor, an improved method of providing real time data in an XAML defined user interface, comprising the steps of;
a. providing a means for predetermined types of data implemented with predetermined communication protocols to participate NET binding in a uniform manner via an enhanced XAML binding syntax and set of predefined software interfaces;
b. providing the means for the source of data in a data binding to change without the need for the binding to be modified, reapplied or destroyed, thereby allowing for dynamic switching of bound data in user interfaces.
c. programming the generic binding interfaces over the top of predetermined types of OPC data to allow a generic mechanism of providing OPC data updated in real time within the XAML defined user interface of software applications.

2. The process of claim 1, wherein real time data is obtained from a data source.

3. The process of claim 1, wherein the data is to be bound to properties on user interface controls with the binding expressed in the XAML markup language.

4. The process of claim 1, wherein the mechanisms used to bind the data items are identical regardless of the data source providing the data.

5. The process of claim 1, wherein the generic mechanism used to bind the data items is a NET class derived from the .NET Binding class with custom properties. This class replaces the class typically used in .NET binding.

6. The process of claim 1, wherein XAML defines the values to be applied on the generic binding, or provides a reference to a resource that defines the value to be applied.

7. The process of claim 6, wherein the generic binding contains a Property property used to define the property to be bound to.

8. The process of claim 6, wherein the generic binding contains a PathAlias property to provide the name of a Path Alias.

9. The process of claim 6, wherein the generic binding contains a PathPart property used in conjunction with the Path Alias to create an identifier for the data item being bound to.

10. The process of claim 6, wherein the generic binding contains a GenericDataSource property used in conjunction with the Path Alias name to locate the Path Alias.

11. The process of claim 1, wherein the data source for a particular set of real time data implements a predefined interface for the generic binding mechanism to communicate with such interface is known as lGenericDataSource.

12. The process of claim 1, wherein the application at design time asks the predefined interface in 11 for available Path Alias's and asks the Alias for descriptions of available items for binding, which are returned to the application as a predefined IGenericDataItem interface.

13. The process of claim 1, wherein when the application determines a binding is to be created; the application will create a generic binding specifying an lGenericDataSource, the name of a property to bind to and the name of a Path Alias and Path Part to describe the item needed for binding.

14. The process of claim 1, wherein when the application determines a binding is to be created, generic binding will locate a Path Alias as a child of the data source using the Path Alias name. The generic binding will ask the Path Alias for an IGenericDataItem passing the Path Part to the Alias to assist the Alias in locating the item. The Path Alias will return an IGenericDataItem to be used as the source of the binding along with the Property property that was specified on the generic binding.

15. The process of claim 1, wherein the implementation of the data source is abstracted away via a generic interface and the implementation of the data item bound to is abstracted away using a generic interface.

16. The process of claim 1, wherein the underlying object updating the data item can be changed by modifying a relative component of the description of the data item. In generic binding, this is accomplished by modifying the path of the Path Alias, thereby modifying the descriptions of the child IGenericDataItems. As an items description is comprised of the path of the Path Alias plus the Path Part of the lGenericDataItem, modification of the path of the Path Alias causes a change in the description of the IGenericDataItem, resulting in a change object supplying property updates to the IGenericDataItem.

17. The process of claim 1, the object providing the data to the IGenericDataItem and ultimately the generic binding can change via the Path Alias, without the need for the generic binding to be changed, or recreated.

18. A method of providing different kinds real time OPC data into an XAML defined user interface of a NET or Silverlight application, comprising the steps of;
a. Creating a client software component which implements the IGenericDataSource for communicating with generic binding in both configuration and design time.
b. Modifying the client component to be an OPC client to a particular set of OPC data.
c. Replacing the typical binding class used in XAML with the generic binding mechanisms defined herein.
